(19) United States
(12) Patent Application Publication
(10) Pub. No.: US 2017/0264792 A1
(43) Pub. Date: Sep. 14, 2017

(54) METHOD OF SYNCHRONIZING DATA AND ELECTRONIC DEVICE AND SYSTEM FOR IMPLEMENTING THE SAME

(71) Applicant: SAMSUNG ELECTRONICS CO., LTD., Suwon-si (KR)

(72) Inventors: Taekyung LEE, Suwon-si (KR); Wootaek SONG, Suwon-si (KR); Donghyoun SON, Suwon-si (KR)

(21) Appl. No.: 15/458,263

(22) Filed: Mar. 14, 2017

(30) Foreign Application Priority Data
Mar. 14, 2016 (KR) 10-2016-0030541

(51) Int. Cl. H04N 5/04; G06F 13/38; G06F 13/42; G06F 3/14; G06F 3/01

(52) U.S. Cl. CPC H04N 5/04; G06F 3/1423; G06F 3/012; G06F 13/4282; G06F 13/385

(57) ABSTRACT

A method of synchronizing data and an electronic device and system for implementing the same are provided. The head mounted device includes: a housing including a surface; a connection device connected to the housing to detachably connect the housing to a portion of a user head; a display exposed through a portion of the surface; a motion sensor located at the housing or connected to the housing configured to provide a first signal representing a movement of the housing; a communication circuit; a processor electrically connected to the display and the wire communication circuit; and a memory electrically connected to the processor and configured to store instructions, wherein the processor is configured to execute the instructions to receive the first signal from the motion sensor, to transmit first information based on the first signal using the communication circuit, to transmit second information including a time related to the first signal using the communication circuit, to receive multimedia data and third information related to the multimedia data corresponding to a time using the communication circuit, to discard a portion of the multimedia data based on the second information and the third information, and to display an image on the display using the multimedia data whose portion is discarded and to output audio using an audio output module.

### CROSS-REFERENCE TO RELATED APPLICATION

This application is based on and claims priority under 35 U.S.C. §119 to a Korean patent application filed on Mar. 14, 2016, in the Korean Intellectual Property Office and assigned Serial No. 10-2016-0030541, the disclosure of which is incorporated by reference herein in its entirety.

### TECHNICAL FIELD

The present disclosure relates generally to a method of synchronizing data and an electronic device and system for implementing the same.

### BACKGROUND

Electronic devices, for example a smart phone, tablet Personnel Computer (PC), and laptop computer have been used in a very wide field due to use convenience and easy portability. Further, nowadays, various electronic devices of a form that can directly wear in a human body have been developed. Such devices are referred to as a wearable electronic device. For example, the wearable electronic device may include a Head-Mounted Display or a Head-Mounted Device (HMD), smart glasses, smart watch or wristband, contact lens type device, ring type device, shoes type device, clothing type device, and glove type device and may have various forms to be detached to a portion of a human body or clothing.

The wearable electronic devices may be connected to another electronic device (e.g., a smart phone, laptop computer, tablet PC) to transmit and receive data.

In order to display the image data, the wearable electronic device may require synchronization of data. For synchronization of the image data, the wearable device may be connected to another electronic device through an interface (e.g., Mobile High-Definition Link (MHL) or High Definition Multimedia Interface (HDMI)) that can autonomously perform synchronization or an interface including a separate synchronization line. When the wearable electronic device is connected to another electronic device through an asynchronous interface that may not autonomously perform synchronization, there is a problem that a line for synchronization should be assigned.

### SUMMARY

The present disclosure has been made in view of the above problems and provides a method of synchronizing data and an electronic device and system for implementing the same that can synchronize data without assignment of a separate physical line for synchronization.

The present disclosure further provides a method of synchronizing data and an electronic device and system for implementing the same that can synchronize data (e.g., image data or audio data) received from an external device using time information (timestamp) generated in an electronic device that reproduces contents.

In accordance with an example aspect of the present disclosure, a head mounted device includes: a housing including a surface; a connection device connected to the housing to detachably connect the housing to a portion of a user head; a display exposed through a portion of the surface; a motion sensor located at the housing or connected to the housing configured to provide a first signal representing a movement of the housing; a communication circuit; a processor electrically connected to the display and the communication circuit; and a memory storing instructions and electrically connected to the processor, wherein the processor is configured to execute the instructions to receive the first signal from the motion sensor, to transmit first information based on the first signal using the communication circuit, to transmit second information including a time related to the first signal using the communication circuit, to receive multimedia data and third information related to the multimedia data corresponding to a time using the communication circuit, to discard a portion of the multimedia data based on the second information and the third information, to display an image on the display using the multimedia data whose portion is discarded, and to output audio using an audio output module comprising audio output circuitry.

In accordance with another example aspect of the present disclosure, an electronic device includes: a communication circuit; a memory configured to store multimedia data and instructions; and a processor electrically connected to the communication circuit and the memory, wherein the processor is configured to execute the instructions to receive time information from another electronic device connected through a communication circuit using the communication circuit, to encode multimedia data to include the received time information, and to transmit the encoded multimedia data to the another electronic device using the communication circuit.

In accordance with another example aspect of the present disclosure, a method of synchronizing data of a head mounted device includes: transmitting first information based on a first signal representing a movement of the head mounted device to an electronic device connected through a wire communication circuit using the wire communication circuit; transmitting second information including a time related to the first signal to the electronic device using the wire communication circuit; receiving multimedia data and third information related to the multimedia data corresponding to a time from the electronic device using the communication circuit; discarding a portion of the multimedia data based on the second information and the third information; and displaying an image on a display using the multimedia data whose portion is discarded and outputting audio using an audio output device.

In accordance with another example aspect of the present disclosure, a method of synchronizing data of an electronic device includes: detecting a connection with another electronic device through a communication circuit; receiving time information for synchronization from the another electronic device through the communication circuit; encoding multimedia data to include the received time information; and transmitting the encoded multimedia data to the another electronic device using the communication circuit.

In accordance with another example aspect of the present disclosure, a data synchronization system includes: a first electronic device that transmits time information for synchronization using a communication circuit and that receives multimedia data including the time information using the communication circuit and that displays an image on a display using the received multimedia data and that outputs audio using an audio output device; and a second electronic device that encodes multimedia data to include the time information received from the first electronic device corresponding to reception of the time information and that transmits the encoded multimedia data to the first electronic device using the communication circuit.

### BRIEF DESCRIPTION OF THE DRAWINGS

These and other aspects, features, and attendant advantages of the present disclosure will be more apparent and readily understood from the following detailed description, taken in conjunction with the accompanying drawings, in which like reference numerals refer to like elements, and wherein:

FIG. 1 is a diagram illustrating an example data synchronization system according to various example embodiments of the present disclosure;

FIG. 2 is a block diagram illustrating an example interface structure of electronic devices according to various example embodiments of the present disclosure;

FIG. 3 is a block diagram illustrating an example configuration of an electronic device according to various example embodiments of the present disclosure;

FIG. 4 is a block diagram illustrating an example configuration of an electronic device according to various example embodiments of the present disclosure;

FIG. 5 is a diagram illustrating an example method of transmitting image data of an electronic device according to various example embodiments of the present disclosure;

FIG. 6 is a flow diagram illustrating an example method of synchronizing data of a data synchronization system according to various example embodiments of the present disclosure;

FIG. 7 is a diagram illustrating an example structure of a data packet for transmitting sensor data and time information according to various example embodiments of the present disclosure;

FIG. 8 is a diagram illustrating an example packet structure for transmitting image data according to various example embodiments of the present disclosure;

FIG. 9 is a diagram illustrating an example packet structure for transmitting image data according to various example embodiments of the present disclosure;

FIG. 10 is a diagram illustrating an example method of synchronizing data according to various example embodiments of the present disclosure;

FIG. 11 is a flow diagram illustrating an example method of synchronizing data according to various example embodiments of the present disclosure;

FIG. 12 is a flow diagram illustrating an example method of synchronizing data according to various example embodiments of the present disclosure;

FIG. 13 is a flow diagram illustrating an example method of synchronizing data according to various example embodiments of the present disclosure;

FIG. 14 is a flowchart illustrating an example method of synchronizing data of an electronic device according to various example embodiments of the present disclosure; and

FIG. 15 is a flowchart illustrating an example method of synchronizing data of an electronic device according to various example embodiments of the present disclosure.

### DETAILED DESCRIPTION

Hereinafter, various example embodiments of the present disclosure are described in greater detail with reference to the accompanying drawings. In the following description of the various example embodiments, descriptions of well-known functions and structures incorporated herein may be omitted to avoid obscuring the subject matter of the present disclosure and for clarity and conciseness.

The following description with reference to the accompanying drawings is provided to assist in a comprehensive understanding of various example embodiments of the present disclosure as defined by the claims and their equivalents. The following description includes various specific details to assist in that understanding but these are to be regarded as mere examples. Various changes and modifications of the embodiments described herein can be made without departing from the scope and spirit of the present disclosure.

Expressions such as “include” and “may include”, as used herein, may indicate the presence of the disclosed functions, operations, and constituent elements, but do not limit one or more additional functions, operations, and constituent elements. Herein, terms such as “include” and/or “have” may be construed to indicate a certain characteristic, number, step, operation, constituent element, component or a combination thereof, but may not be construed to exclude the existence of, or a possibility of, one or more other additional characteristics, numbers, steps, operations, constituent elements, components or combinations thereof.

In the present disclosure, the expression “and/or” includes any and all combinations of the associated listed words. For example, the expression “A and/or B” may include A, include B, or both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions merely distinguish an element from the other elements. For example, a first user device and a second user device indicate different user devices although both devices are user devices. For example, a first element could be referred to as a second element, and similarly, a second element could also be referred to as a first element without departing from the scope of the present disclosure.

When is referred to as being “connected” to or “accessed” by to other component, not only is the component directly connected to or accessed by the other component, but also there may exist another component between them. Meanwhile, when a component is referred to as being “directly connected” or “directly accessed” to other component, it should be understood that there is no component therebetween.

The terms used in the present disclosure are merely used to describe specific embodiments of the present disclosure, and are not intended to limit the present disclosure. As used herein, the singular forms of terms are intended to include the plural forms as well, unless the context clearly indicates otherwise.

In this disclosure, an electronic device may be able to perform a communication function. For example, an electronic device may be a smart phone, a tablet personal computer (PC), a mobile phone, a video phone, an e-book reader, a desktop PC, a laptop PC, a netbook computer, a personal digital assistant (PDA), a portable multimedia player (PMP), a Moving Picture Experts Group (MPEG) audio layer 3 (MP3) player, a portable medical device, a digital camera, or a wearable device (e.g., a head-mounted device (HMD) such as electronic glasses, electronic clothes, an electronic bracelet, an electronic necklace, an electronic appcessory, or a smart watch), or the like, but is not limited thereto.

According to some embodiments of the present disclosure, an electronic device may be a smart home appliance that involves a communication function. For example, an electronic device may be a television (TV), a digital video disk (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame, or the like, but is not limited thereto.

According to some embodiments of the present disclosure, an electronic device may be a medical device (e.g., magnetic resonance angiography (MRA), magnetic resonance imaging (MRI), computed tomography (CT), ultrasonography, etc.), a navigation device, a global positioning system (GPS) receiver, an event data recorder (EDR), a flight data recorder (FDR), a car infotainment device, electronic equipment for a ship (e.g., a marine navigation system, a gyrocompass, etc.), avionics, security equipment, or an industrial or home robot, or the like, but is not limited thereto. According to some embodiments of the present disclosure, an electronic device may be furniture or part of a building or construction having a communication function, an electronic board, an electronic signature receiving device, a projector, or various measuring instruments (e.g., a water meter, an electric meter, a gas meter, a wave meter, etc.), or the like, but is not limited thereto. An electronic device disclosed herein may be one of the above-mentioned devices or any combination thereof. The above-mentioned electronic devices are merely listed as examples and not to be considered as a limitation of this disclosure.

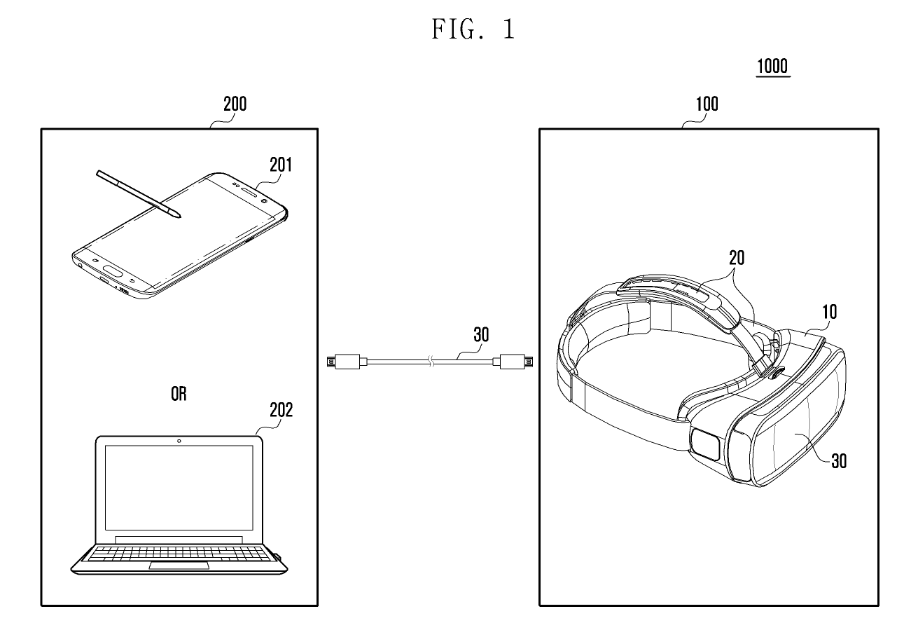

FIG. 1 is a diagram illustrating an example data synchronization system according to various example embodiments of the present disclosure.

With reference to FIG. 1, a system 1000 according to various example embodiments of the present disclosure may include a first electronic device 100 and a second electronic device 200.

The first electronic device 100 may be a device for outputting contents (multimedia data) received from the second electronic device 200. As illustrated in FIG. 1, the first electronic device 100 may be a Head-Mounted Device (HMD) including a housing 10, connection device (e.g., a strap) 20 connected to the housing 10 to detachably connect the housing 10 to a portion of a user head, and display 30 exposed through a portion of a surface of the housing 10. However, the first electronic device 100 according to an example embodiment of the present disclosure is not limited to the HMD.

The second electronic device 200 may be a content sharing device that may store contents and that may share the stored contents. For example, as illustrated in FIG. 1, the second electronic device 200 may be a smart phone 201 and a laptop computer 202, or the like. However, the second electronic device 200 according to an example embodiment of the present disclosure is not limited thereto and may be various electronic devices (e.g., a tablet PC, a Person Digital Assistant (PDA)) that can store and share contents.

The second electronic device 200 may share stored contents with the first electronic device 100. For example, the second electronic device 200 may provide real time contents to the first electronic device 100. In order to share the contents, the first electronic device 100 and the second electronic device 200 may be connected through a physical interface (e.g., a wire communication circuit). For example, as illustrated in FIG. 1, the first electronic device 100 and the second electronic device 200 may be connected through a cable 30. According to an example embodiment, the first electronic device 100 and the second electronic device 200 may be directly connected without a cable. For example, the first electronic device 100 may include a connector at one side, and the second electronic device 200 may include a socket corresponding to the connector.

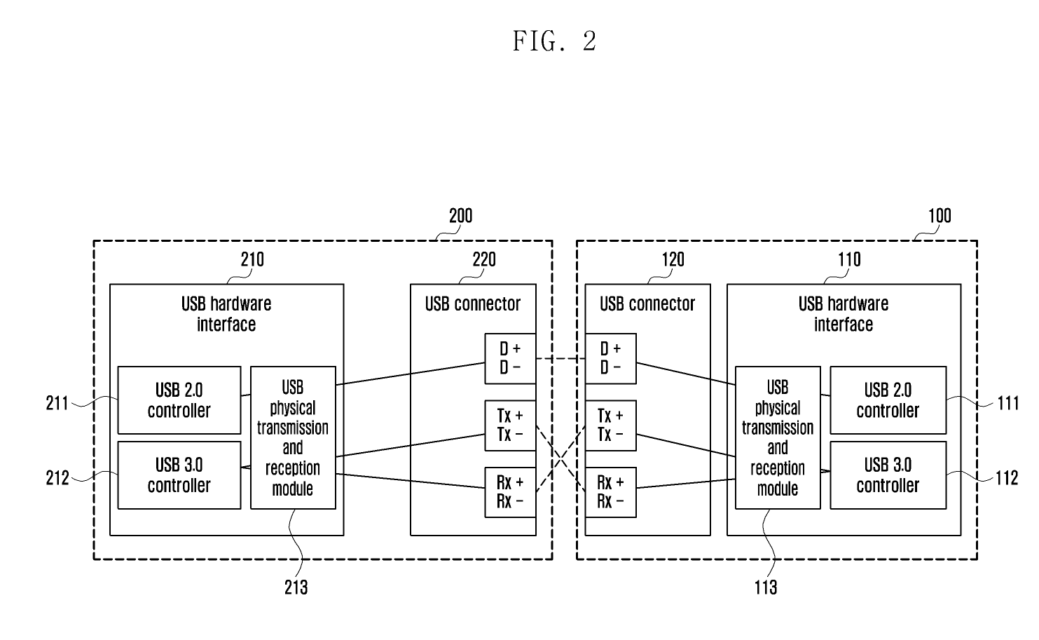

The physical interface may be an interface of a method that may not autonomously perform synchronization or that does not include a separate signal line for synchronization. A more detailed description of the physical interface will be provided with reference to FIG. 2.

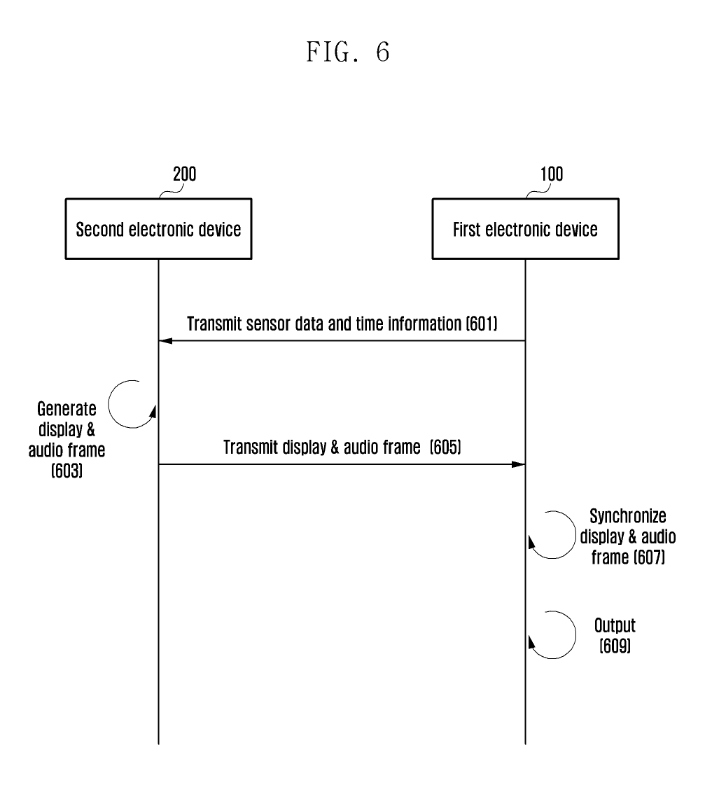

The first electronic device 100 and the second electronic device 200 may synchronize data using a physical interface. For example, the first electronic device 100 and the second electronic device 200 may perform synchronization using internal time information of the first electronic device 100. A more detailed description of the synchronizing method will be provided below with reference to FIGS. 6 to 11.

FIG. 2 is a block diagram illustrating an example interface structure of electronic devices according to various example embodiments of the present disclosure.

With reference to FIG. 2, the electronic devices 100 and 200 according to various example embodiments of the present disclosure may include Universal Serial Bus (USB) hardware interfaces 110 and 210 and USB connectors 120 and 220, respectively. For example, the electronic devices 100 and 200 may be connected through an interface of a USB Type-C specification.

The USB hardware interfaces 110 and 210 may include USB 2.0 controllers 111 and 211, USB 3.0 controllers 112 and 212, and USB physical transmission and reception modules 113 and 213, respectively.

The USB 2.0 controllers 111 and 211 may control data transmission and reception according to a USB 2.0 specification. The first electronic device 100 according to an example embodiment of the present disclosure may transmit first information (sensor data) based on a signal (first signal) corresponding to a movement of the first electronic device 100 received from a sensor (e.g., a motion sensor) to the second electronic device 200 through a USB 2.0 interface. Further, the first electronic device 100 may transmit information (second information) about a time related to the signal (first signal) to the second electronic device 200 through the USB 2.0 interface.

The USB 3.0 controllers 112 and 212 may control data transmission and reception according to a USB 3.0 specification. The second electronic device 200 according to an example embodiment of the present disclosure may transmit third information and contents (multimedia data) related to the multimedia data to correspond to a time to the first electronic device 100 through a USB 3.0 interface. For example, the second electronic device 200 may encode contents in order to include the received second information to generate a data frame and may transmit the generated data frame to the first electronic device 100 through the USB 3.0 interface.

The USB physical transmission and reception modules 113 and 213 may convert data according to a USB 2.0 specification or a USB 3.0 specification to a physical signal.

The USB connectors 120 and 220 are a physical connector for connecting to an external device. For example, the USB connectors 120 and 220 may be a USB Type-C connector described at a USB standard. The USB Type-C connector may provide an alternate mode for connecting to a non-USB device. In this way, the USB Type-C connector may transmit and receive USB data or non-USB data. For example, the USB connectors 120 and 220 may include a terminal (e.g., D+, D−) for supporting a USB 2.0 interface and a terminal (e.g., Tx+, Tx−, Rx+, Rx−) for supporting a USB 3.0 interface.

As described above, the first electronic device 100 according to an example embodiment of the present disclosure may be connected to the second electronic device 200 through two interfaces (e.g., USB 2.0 interface, USB 3.0 interface), transmit time information for synchronization to the second electronic device 200 through a first interface (e.g., USB 2.0 interface), and receive encoded contents using time information through the second interface (e.g., USB 3.0 interface). In other words, the first electronic device 100 and the second electronic device 200 according to an example embodiment of the present disclosure may use the USB 2.0 interface and the USB 3.0 interface, respectively, for different uses.

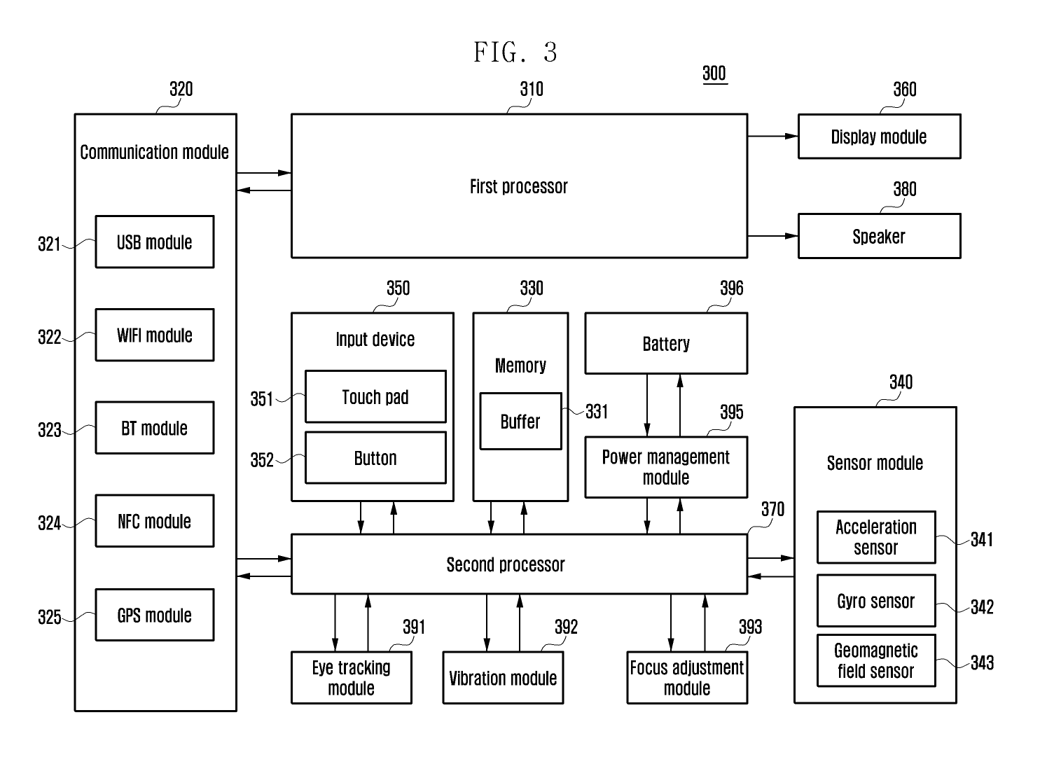

FIG. 3 is a block diagram illustrating an example configuration of an electronic device according to various example embodiments of the present disclosure.

With reference to FIG. 3, an electronic device 300 (e.g., the electronic device 100) according to various example embodiments of the present disclosure may include a first processor (e.g., including processing circuitry) 310, communication module (e.g., including communication circuitry) 320, memory 330, sensor module 340, input device (e.g., including input circuitry) 350, display module 360, second processor (e.g., including processing circuitry) 370, speaker 380, eye tracking module 391, vibration module 392, focus adjustment module 393, power management module 395, and battery 396.

The first processor 310 may include various processing circuitry and perform a function related to an output of multimedia data. For example, the first processor 310 may process (decode and synchronize) multimedia data by driving an Operating System (OS) or an embedded software program and control a plurality of hardware components (e.g., the display module 360 and the speaker 380) in order to output the processed multimedia data. The first processor 310 may be formed with a Micro Control Unit (MCU).

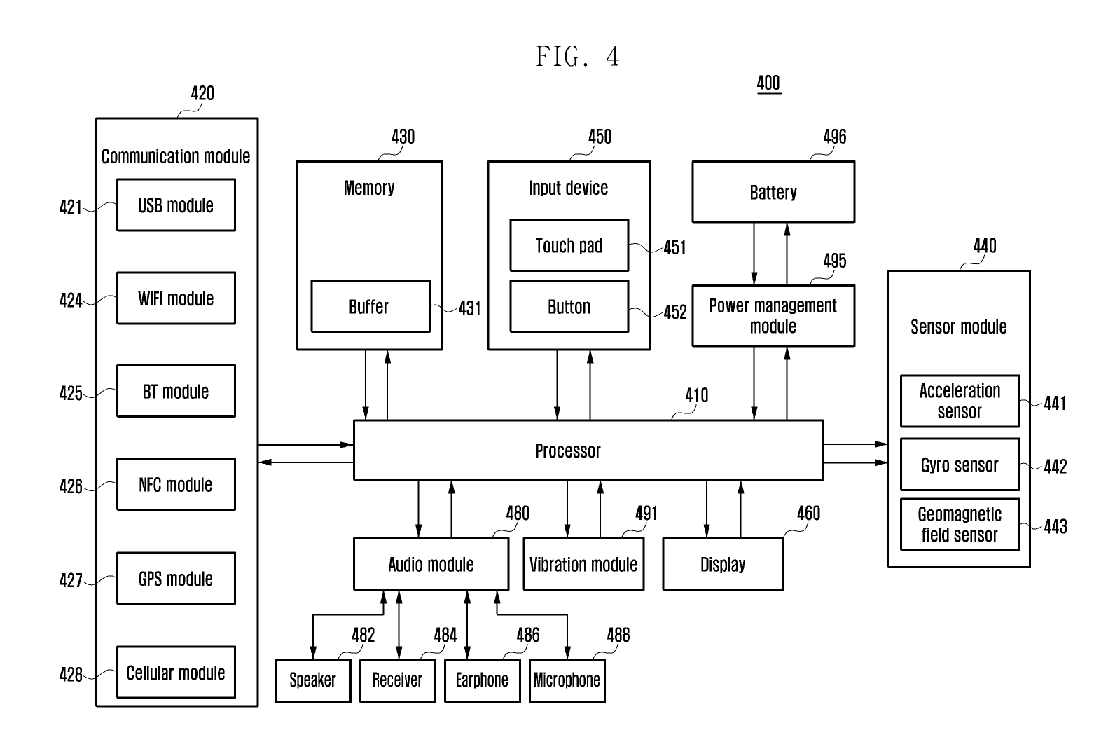

The first processor 310 may receive time information (third information) and multimedia data from another electronic device (e.g., the second electronic device 200) or an electronic device 400 of FIG. 4 to be described later connected through a communication circuit, such as, for example, a wire communication circuit (e.g., a USB module 321). For example, the first processor 310 may receive multimedia data including the time information through the USB 3.0 interface of the USB module 321. The first processor 310 may process (e.g., decode and synchronize) the received multimedia data to transmit the processed data to an output module, for example the display module 360 and the speaker 380. For this reason, the first processor 310 may include a decoder (not shown). The decoder may include a display decoder and an audio decoder. According to an example embodiment, the decoder may be included in another configuration instead of the first processor 310 or may be included in a separate configuration.

The communication module 320 may be electrically connected to the second electronic device and may include various communication circuitry to perform communication. The communication module 320 may perform communication by wire or wireless. The communication module 320 may include various communication circuitry, such as, for example, and without limitation, a USB module 321, WiFi module 322, Bluetooth (BT) module 323, Near Field Communication (NFC) module 324, and Global Positioning System (GPS) module 325. According to an example embodiment, at least a portion (e.g., two or more) of the WiFi module 322, BT module 323, NFC module 324, and GPS module 325 may be included in an Integrated Chip (IC) or an IC package.

The USB module 321 according to an example embodiment of the present disclosure may support a USB Type-C including a USB 2.0 interface and a USB 3.0 interface. As described in FIG. 2, the USB module 321 may be formed with a USB hardware interface and a USB connector.

The memory 330 may include a volatile memory and/or a non-volatile memory. The memory 330 may store, for example, instructions or data related to at least one other element of the electronic device 300. According to an embodiment, the memory 330 may store software and/or a program.

The memory 330 may include an external memory functionally or physically connected to the electronic device 300 through, for example an internal memory or various interfaces. The memory 330 according to an example embodiment of the present disclosure may include a buffer 331 that temporarily stores the received multimedia data. According to an example embodiment, the buffer 331 may be included in the first processor 310 or may be included in a separate configuration.

The sensor module 340 may measure a physical quantity or detect an operation state of the electronic device 300 to convert measured or detected information to an electrical signal. The sensor module 340 may include at least one of an acceleration sensor 341, gyro sensor 342, and geomagnetic field sensor 343. Further, although not shown, the sensor module 340 may additionally or alternatively include a gesture sensor, atmospheric pressure sensor, magnetic sensor, grip sensor, proximity sensor, color sensor (e.g., Red, Green, and Blue (RGB) sensor), bio sensor, temperature/humidity sensor, illumination sensor, Ultra Violet (UV) sensor, e-nose sensor, electromyography (EMG) sensor, electroencephalogram (EEG) sensor, electrocardiogram (ECG) sensor, infrared (IR) sensor, iris sensor and/or fingerprint sensor. The sensor module 340 may further include a control circuit for controlling at least one sensor that belongs thereto.

The sensor module 340 according to various example embodiments of the present disclosure may detect a movement of the electronic device 300. For example, the sensor module 340 may detect a head movement of a user who wears the electronic device 300 using the acceleration sensor 341, gyro sensor 342, and geomagnetic field sensor 343. Alternatively, the sensor module 340 may detect whether the electronic device 300 is worn using a proximity sensor or a grip sensor. According to an example embodiment, the sensor module 340 may detect at least one of IR recognition, pressing recognition, and a change amount of capacitance (or a dielectric constant) according to user wearing to detect whether the user wears. The gesture sensor may detect a movement of a user hand or finger to receive the movement as an input operation of the electronic device 300. Additionally or alternatively, the sensor module 340 may recognize a user's bio information using a bio recognition sensor such as an e-nose sensor, EMG sensor, EEG sensor, ECG sensor, and iris sensor.

The input device 350 may include various input circuitry, such as, for example, and without limitation, a touch panel 351, or a key 352. The touch panel 351 may use at least one of, for example, a capacitive scheme, a resistive scheme, an infrared scheme, and an ultrasonic scheme. Further, the touch panel 351 may further include a control circuit. The touch panel 351 may further include a tactile layer and provide a tactile reaction to the user.

The key 352 may include, for example, a physical button, an optical key or a keypad. According to an embodiment, the input device 350 may further include a (digital) pen sensor, and/or an ultrasonic input unit.

The display module 360 may include a panel, a hologram device or a projector. The panel may be implemented to be, for example, flexible, transparent, or wearable. The panel and the touch panel 351 may be implemented as one module. The hologram device may show a three dimensional image in the air by using an interference of light. The projector may display an image by projecting light onto a screen. According to an embodiment, the display module 360 may further include a control circuit for controlling the panel, the hologram device, or the projector.

The display module 360 may receive and output display data from the first processor 310. The display data may be synchronized with audio data output through the speaker 380 to be output. The display module 360 may be included in the electronic device 300 or may be detachably connected to the electronic device 300.

The second processor 370 may include various processing circuitry and be configured to control general operations of the electronic device 300 and signal flow between internal elements of the electronic device 300 and perform a data processing function. For example, the second processor 370 may drive an OS or an embedded software program to control the plurality of hardware components (e.g., the communication module 320, memory 330, sensor module 340, input device 350, display module 360, speaker 380, eye tracking module 391, vibration module 392, focus adjustment module 393, power management module 395, and battery 396). The second processor 370 may be formed with a Central Processing Unit (CPU), Application Processor (AP), and Micro Control Unit (MCU). The second processor 370 may be formed as a single core processor or a multi-core processor.

The second processor 370 according to an example embodiment of the present disclosure may transmit sensor data (first information) and/or time information (second information) to another electronic device. For example, the second processor 370 may transmit time information and/or sensor data to another electronic device through a USB 2.0 interface of the USB module 321.

The speaker 380 may receive and output audio data from the first processor 310. The audio data may be synchronized with display data output through the display module 360 to be output.

The eye tracking module 391 may track a user sight line. For example, the eye tracking module 391 may track the user sight line using at least one method of an Electrooculography (EOG) sensor, Coil systems, Dual Purkinje systems, Bright pupil systems, and Dark pupil systems. According to an example embodiment, the eye tracking module 391 may further include a micro camera for tracking a sight line.

In order to provide an event to the user, the vibration module 392 may occur a vibration. In order for the user to view an image appropriate to sight thereof, the focus adjustment module 393 may measure the user's Inter-Pupil Distance (IPD) and adjust a lens distance and a location of the display module 360.

The power management module 395 may manage, for example, power of the electronic device 300. According to an embodiment, the power management module 395 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery, and a voltage, a current, or a temperature during the charging.

The battery 396 may supply power for driving the electronic device 300. For example, the battery 396 may include a rechargeable battery and/or a solar cell. FIG. 3 illustrates the battery 396 included in the electronic device 300. However, the battery 396 may be functionally connected through the external electronic device (e.g., the second electronic device 200).

In FIG. 3, the electronic device 300 includes the first processor 310 and the second processor 370. However, according to an example embodiment, one processor may perform an entire function of the first processor 310 and the second processor 370. For example, the first processor 310 may together perform a function of the second processor 370 or the second processor 370 may together perform a function of the first processor 310.

The electronic device 300 may not include a portion of the above-described elements. Alternatively, the electronic device 300 may further include various elements (e.g., camera, microphone) of a level equivalent to the above-described elements. A head mounted device (e.g., the first electronic device 100 or the electronic device 300) according to various example embodiments of the present disclosure includes: a housing (e.g., the housing 10 of FIG. 1) including a surface, wherein the housing is configured to be detachably connected to a portion of a user's head, an example of a configuration for connecting the housing to a portion of the user's head may include, a connection device (e.g., the connection device 20 of FIG. 1) connected to the housing to detachably connect the housing to a portion of a user head; a display (e.g., the display 30 of FIG. 1 or the display module 360 of FIG. 3) exposed through a portion of the surface; a motion sensor (e.g., the sensor module 340) located at the housing or connected to the housing to provide a first signal representing a movement of the housing; a communication circuit (e.g., the USB module 321); a processor (e.g., the first processor 310 and the second processor 370) electrically connected to the display and the communication circuit; and a memory (e.g., the memory 330) electrically connected to the processor and configured to store instructions, wherein the processor is configured to execute the instructions to receive the first signal from the motion sensor, to transmit first information based on the first signal using the communication circuit, to transmit second information including a time related to the first signal using the communication circuit, to receive multimedia data and third information related to the multimedia data corresponding to a time using the communication circuit, to discard a portion of the multimedia data based on the second information and the third information, to display an image on the display using the multimedia data whose portion is discarded, and to output audio using an audio output module (e.g., the speaker 380).

According to various example embodiments, the communication circuit may correspond to a USB 3.0 type-C specification.

According to various example embodiments, the communication circuit may include: a first interface that transmits the first information and the second information; and a second interface that receives the multimedia data and the third information.

According to various example embodiments, the multimedia data may include a display frame and an audio frame, and the communication circuit may receive the display frame and the audio frame using one endpoint or may receive the display frame or the audio frame using different endpoints.

According to various example embodiments, the memory may further store an instruction to synchronize display data included in the display frame and audio data included in the audio frame using time information included in each of the display frame and the audio frame.

According to various example embodiments, the processor may discard a portion of the received multimedia data, if a difference between the second information and the third information is a predetermined reference value or more.

According to various example embodiments, the processor may share output time information with another head mounted device connected by wire or wirelessly.

FIG. 4 is a block diagram illustrating an example configuration of an electronic device according to various example embodiments of the present disclosure.

With reference to FIG. 4, an electronic device 400 (e.g., the second electronic device 200) according to an example embodiment of the present disclosure may include a processor (e.g., including processing circuitry) 410, communication module (e.g., including communication circuitry) 420, memory 430, sensor module 440, input device (e.g., including input circuitry) 450, display 460, audio module 480, vibration module 491, power management module 495, and battery 496.

The processor 410 may include various processing circuitry configured to control general operations of the electronic device 400 and signal flow between internal elements of the electronic device 400 and have a data processing function. For example, the processor 410 may include various processing circuitry, such as, for example, and without limitation, a dedicated processor, a Central Processing Unit (CPU), Application Processor (AP), and Communication Processor (CP), or the like. The processor 410 may be formed as a single core processor or a multi-core processor. Further, the processor 410 may be formed as a plurality of processors.

The processor 410 according to an example embodiment of the present disclosure may receive time information for synchronization from another electronic device (e.g., the first electronic device 100, the electronic device 300) connected through a wire communication circuit (e.g., a USB module 421). For example, the processor 410 may receive the time information through a USB 2.0 interface of the USB module 421.

The processor 410 may encode multimedia data using received time information. For example, the processor 410 may include time information received in display data and audio data constituting the multimedia data to generate a display frame and an audio frame. For this reason, the processor 410 may include an image processing module and an encoder. The encoder may include a display encoder and an audio encoder. According to an example embodiment, the encoder may be included in a separate configuration instead of including in the processor 410. Further, the display encoder and the audio encoder each may be included in different configurations. For example, the display encoder may be included in the processor 410, and the audio encoder may be included in the audio module 480.

The processor 410 may transmit encoded multimedia data to another electronic device using the USB module 421. For example, the processor 410 may transmit the display frame and the audio frame to another electronic device using a USB 3.0 interface of the USB module 421. In this case, the processor 410 may transmit a display frame and an audio frame using one endpoint of the USB 3.0 interface or may transmit a display frame or an audio frame using different endpoints.

The memory 430 may store an OS of the electronic device 400 and application programs necessary for other option functions, for example an audio reproduction function, image or moving picture reproduction function, broadcasting reproduction function, Internet access function, text message function, game function, and navigation function. Further, the memory 430 may store various data, for example music data, moving picture data, game data, movie data, and map data. The memory 430 according to an example embodiment of the present disclosure may include a buffer 431. The buffer 431 may temporarily store multimedia data to transmit the multimedia data to another electronic device.

Examples of the display 460 may include a Liquid Crystal Display (LCD), a Light-Emitting Diode (LED) display, an Organic Light-Emitting Diode (OLED) display, a MicroElectroMechanical Systems (MEMS) display, and an electronic paper display, or the like, but is not limited thereto. The display 460 may display, for example, various types of contents (for example, text, images, videos, icons, or symbols) to the user. The display 460 may include a touch screen and receive, for example, a touch input, a gesture input, a proximity input, or a hovering input using an electronic pen or a user's body part.

For example, the audio module 480 may bidirectionally convert between a sound and an electrical signal. The audio module 480 may process sound information which is input or output through, for example, a speaker 482, a receiver 484, earphones 486, the microphone 488 or the like.

The communication module 420 may include various communication circuitry, such as, for example, and without limitation, a USB module 421, WiFi module 424, BT module 425, NFC module 426, GPS module 427, and cellular module 428 for supporting mobile communication. The communication module 420 may perform a function similar to that of the communication module 320 of FIG. 3 except that the cellular module 428 is further included. Therefore, a detailed description of the communication module 420 will be omitted. Further, an acceleration sensor 441, gyro sensor 442, and geomagnetic field sensor 443 of the sensor module 440, touch pad 451 and button key 452 of the input device 450, vibration module 491, power management module 495, and battery 496 perform a function similar to that of the sensor module 340, input device 350, vibration module 392, power management module 395, and battery 396 of FIG. 3. Therefore, a detailed description of the sensor module 440, input device 450, vibration module 491, power management module 495, and battery 496 will be omitted.

Although not illustrated in FIG. 4, the electronic device 400 may further include elements such as a broadcasting reception module for broadcasting reception and various sensor modules such as a camera module. Further, the electronic device 400 according to an example embodiment of the present disclosure may further include elements of a level equivalent to the above-described elements.

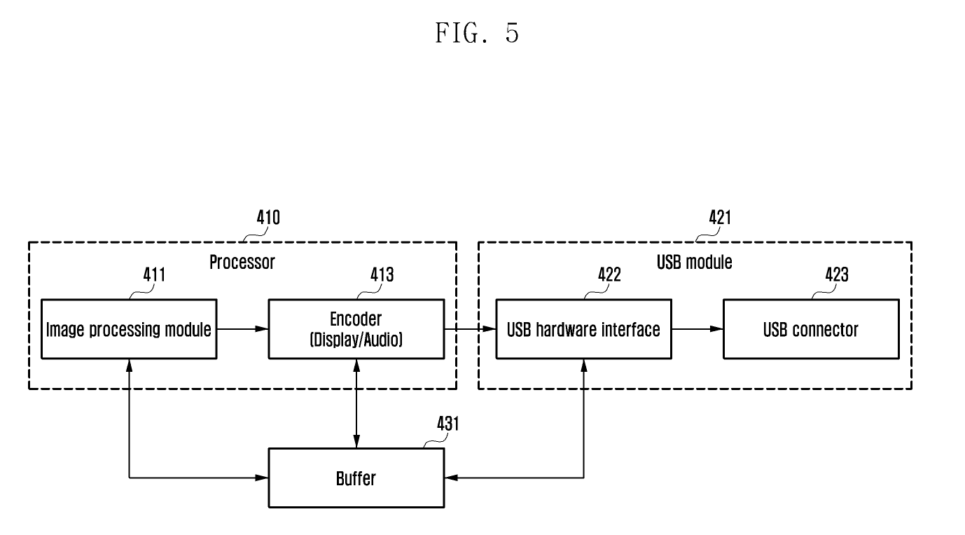

FIG. 5 is a diagram illustrating an example method of transmitting image data of an electronic device according to various example embodiments of the present disclosure.

With reference to FIG. 5, the processor 410 of the electronic device 400 according to various example embodiments of the present disclosure may include an image processing module 411 and an encoder 413. The image processing module 411 and the encoder 413 may be realized in hardware, software, or a combination thereof, e.g., processing circuitry executing program instructions.

The image processing module 411 may read data to transmit to another electronic device from the buffer 431, divide the read data in a packet unit, and add received time information (second information) to each divided data packet. The data packet may include a display packet for outputting a screen and an audio packet for outputting a sound.

The image processing module 411 may transmit a data packet to which the time information is added to the encoder 413. When a load occurs in the encoder 413, the image processing module 411 may store the data packet to which the time information is added at the buffer 431.

The encoder 413 may encode a data packet having added time information transmitted from the image processing module 411 or stored at the buffer 431 according to a specific specification (e.g., USB 3.0). For example, the encoder 413 may encode a display packet using a display encoder and encode an audio packet using an audio encoder. The encoder 413 may transmit the encoded data to the USB module 421 or the buffer 431.

The USB module 421 may include a USB hardware interface 422 and a USB connector 423. The USB hardware interface 422 may convert encoded data packets transmitted from the encoder 413 or stored at the buffer 431 to a physical signal. For example, the USB hardware interface 422 may add an error detection symbol (e.g., Cyclic Redundancy Check (CRC)) to a display packet and an audio packet to convert the display packet and the audio packet to the display frame and the audio frame, respectively. The physical signal may be transmitted to the another electronic device connected through the USB connector 423.

An electronic device (e.g., the second electronic device 200 or the electronic device 400) according to various example embodiments of the present disclosure includes: a communication circuit (e.g., the USB module 421); a memory (e.g., the memory 430) that stores multimedia data and instructions; and a processor (e.g., the processor 410) electrically connected to the wire communication circuit and the memory, wherein the processor is configured to execute the instructions to receive time information from another electronic device connected through the communication circuit using the communication circuit; to encode multimedia data to include the received time information, and to transmit the encoded multimedia data to the another electronic device using the communication circuit.

According to various example embodiments, the communication circuit may correspond to a USB 3.0 type-C specification.

According to various example embodiments, the communication circuit may include: a first interface that receives the time information; and a second interface that transmits the encoded multimedia data.

According to various example embodiments, the multimedia data may include a display frame and an audio frame, and the processor may transmit the display frame and the audio frame using one endpoint or may transmit the display frame or the audio frame using different endpoints.

According to various example embodiments, the memory may further store an instruction to transmit the encoded multimedia data to at least one another electronic device distinguished from the another electronic device when transmitting the encoded multimedia data.

FIG. 6 is a flow diagram illustrating an example data processing procedure of a data synchronization system according to various example embodiments of the present disclosure.

With reference to FIG. 6, a first electronic device 100 and a second electronic device 200 of a data synchronization system 1000 according to various example embodiments of the present disclosure may be connected through a physical interface. For example, the first electronic device and the second electronic device may be connected through an interface corresponding to a USB Type-C specification.

The first electronic device (e.g., the second processor 370 of FIG. 3) may transmit sensor data and time information to the second electronic device (e.g., the processor 410 of FIG. 4) through a communication circuit (e.g., the USB module 321 of FIG. 3) at operation 601. For example, the first electronic device may transmit the sensor data and time information to the second electronic device through a USB 2.0 interface of a wire communication circuit (e.g., the USB module 321 of FIG. 3). The sensor data may be first information based on a first signal representing a movement of the first electronic device. For example, the sensor data may be first information corresponding to a first signal received from an acceleration sensor, geomagnetic field sensor, gyro sensor, and motion sensor. The time information is time information for synchronization and may be second information about a time related to the first signal. The time information may be internal time information of the first electronic device. The internal time information may use clock information of the second processor or the interruption number of a sensor connected to the second processor.

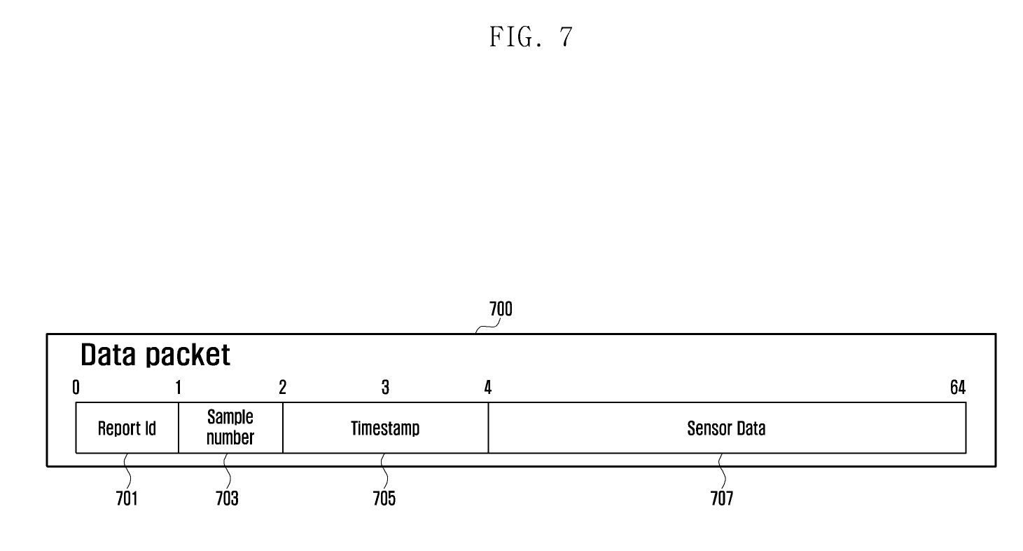

The sensor data and time information may be transmitted in a packet data form. An example structure of packet data of the sensor data and time information will be described in greater detail below with reference to FIG. 7.

The second electronic device may generate a display frame and an audio frame using received time information (second information) at operation 603. For example, the second electronic device may divide multimedia data in a packet unit and add time information in a timestamp form to data divided into each packet unit to generate a display packet and an audio packet. For this reason, the second electronic device may include an encoder. The encoder may be included in one (e.g., a processor) of various configurations of the second electronic device or may be included in a separate configuration. The encoder may include a display encoder that encodes display data and an audio encoder that encodes audio data. The second electronic device (e.g., the USB module 421) may add an error detection symbol to the encoded display packet and audio packet to generate a display frame and an audio frame.

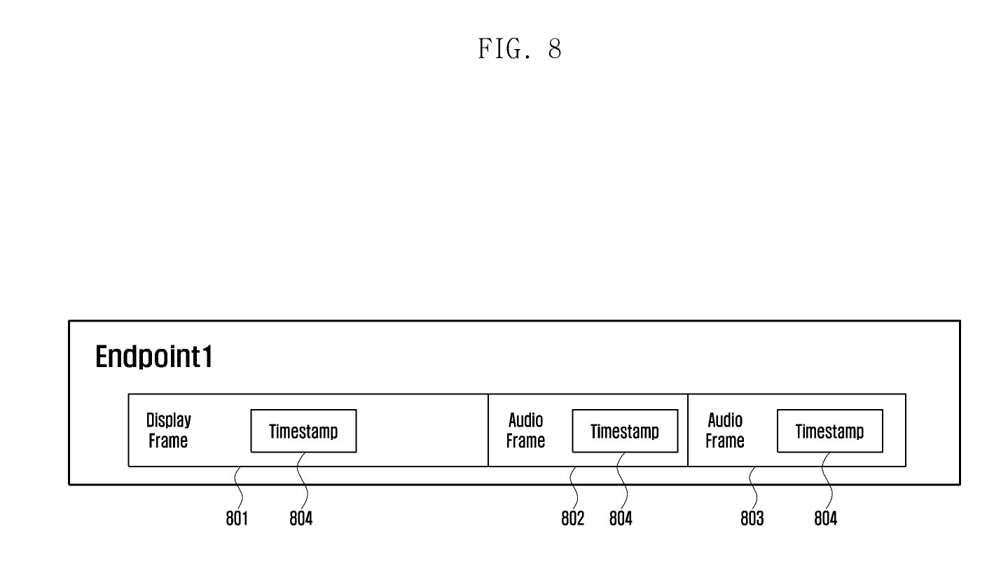

The second electronic device may transmit the generated display frame and audio frame to the first electronic device through a wire communication circuit (e.g., the USB module 421) at operation 605. For example, the second electronic device may transmit the display frame and the audio frame to the second electronic device through a USB 3.0 interface of a wire communication circuit (e.g., the USB module 421). The second electronic device may transmit the display frame and the audio frame using one endpoint that supports in a USB 3.0 standard. A more detailed description thereof will be provided below with reference to FIG. 8.

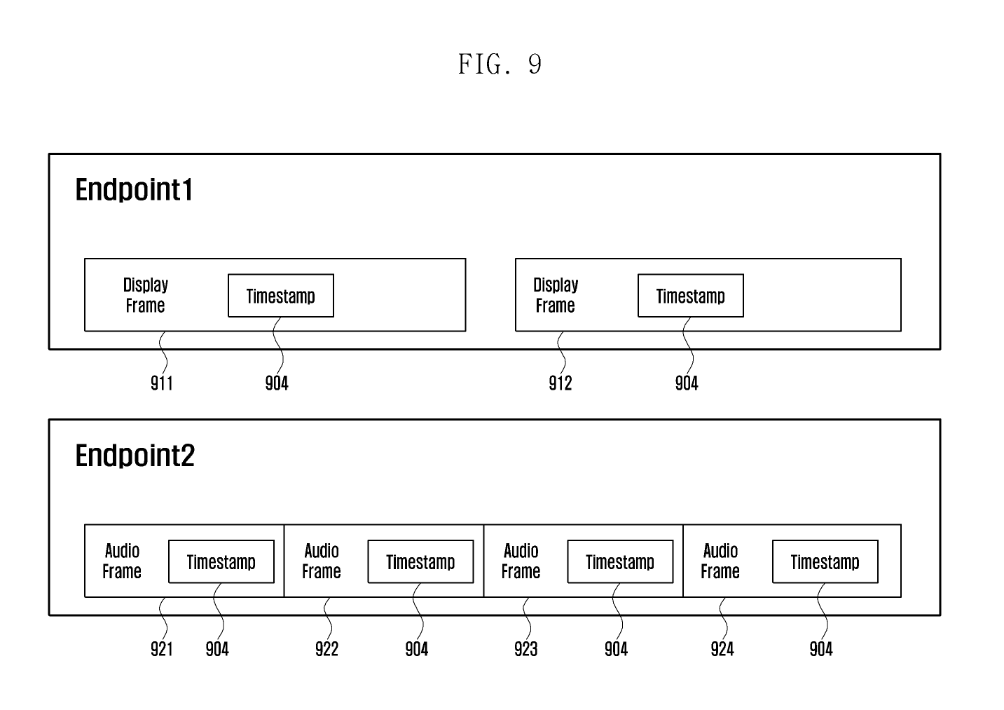

According to an example embodiment, the second electronic device may transmit each of the display packet and the audio packet using a plurality of endpoints that support in a USB 3.0 standard. A more detailed description thereof will be provided below with reference to FIG. 9.

The first electronic device may synchronize the display frame and the audio frame at operation 607. The first electronic device may output multimedia data at operation 609. For example, the first electronic device may control and synchronize to output a display frame and an audio frame having time information (second information) transmitted to the second electronic device at operation 601. For example, when the first electronic device transmits time information of 10 to the second electronic device, the second electronic device may generate a display frame and an audio frame including time information of 10 and transmit the display frame and the audio frame to the first electronic device. In this case, the first electronic device (e.g., the USB module 321 of FIG. 3) may convert the display frame and the audio frame to the display packet and the audio packet.

By decoding the received display packet and audio packet, the first electronic device may control and perform synchronization to output display data and audio data related to time information of 10. The first electronic device may transmit display data and audio data including time information of 10 to the display module and the audio output module (e.g., speaker), respectively. For this reason, the first electronic device may include a decoder. The decoder may be included in one (e.g., a first processor) of various configurations of the first electronic device or may be included in a separate configuration. The decoder may include a display decoder that decodes a display packet and an audio decoder that decodes an audio packet.

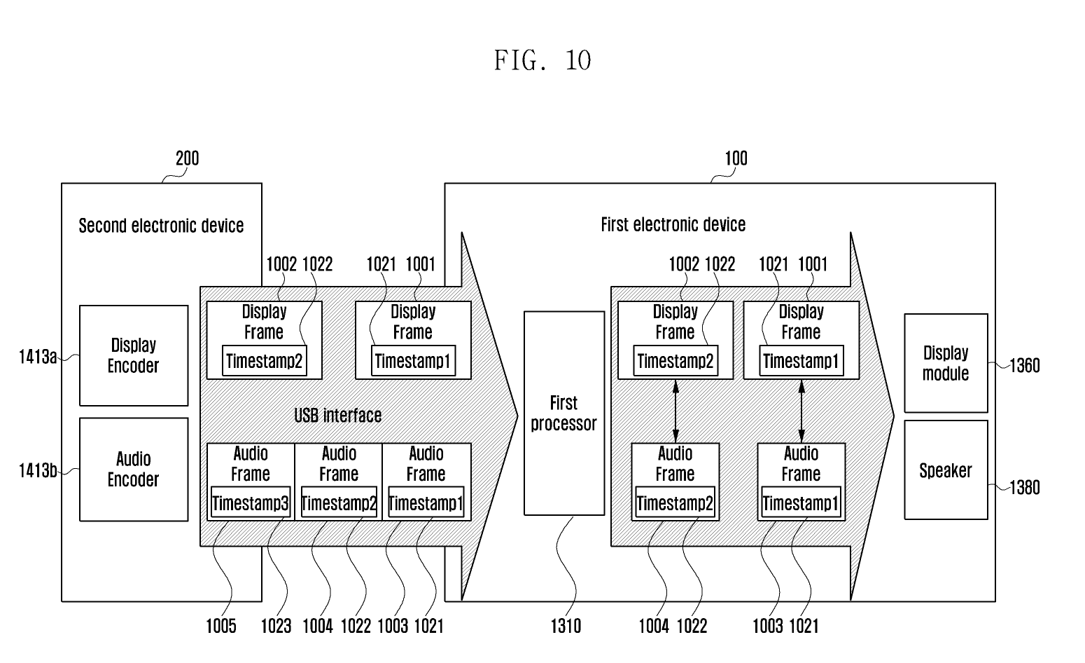

According to an example embodiment, when receiving each of the display frame and the audio frame from the second electronic device, for example when receiving each of the display frame and the audio frame using different endpoints, the first electronic device may synchronize and output display data and audio data using time information included in the received display frame and audio frame. For example, the first electronic device may transmit display data and audio data having the same time information to the display module and the audio output module, respectively. A more detailed description thereof will be described below with reference to FIG. 10.

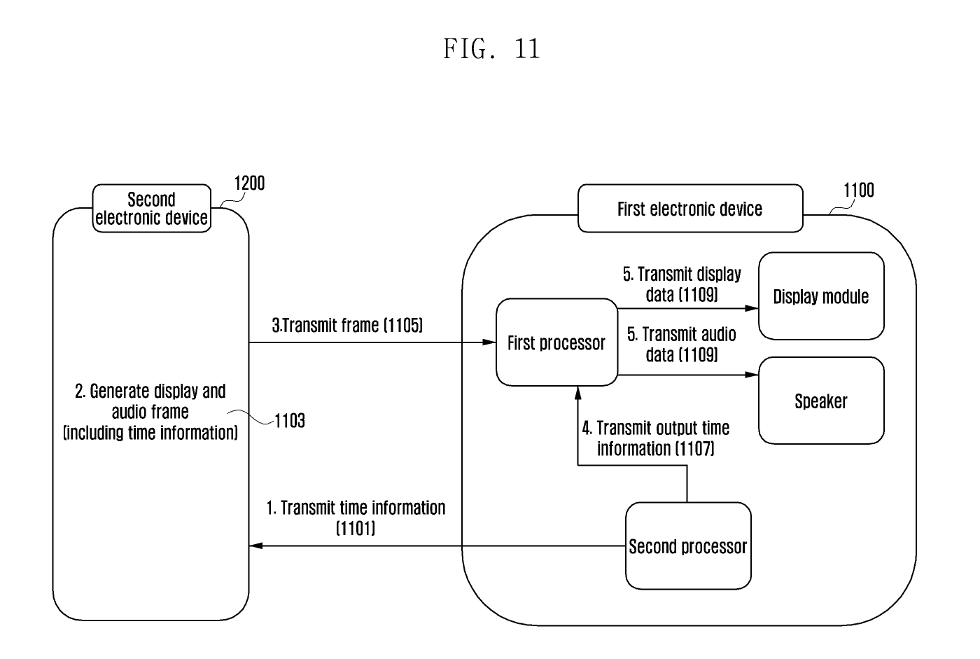

According to an example embodiment, the first electronic device may output display data and audio data corresponding to time information (output time information) received from the second processor instead of time information (second information) transmitted to the second electronic device. A more detailed description thereof will be provided below with reference to FIG. 11.

According to an example embodiment, the first electronic device may discard a portion of received multimedia data and synchronize and output the remaining multimedia data. For example, when processing data in which a real time is important, if a real time is not guaranteed due to increase of latency (e.g., as a data amount to process rapidly increases or as an overload occurs, when a difference between second information and third information is a reference value or more), the first electronic device may delete (or discard) multimedia data having old time information and output the remaining multimedia data.

A data synchronization system according to various example embodiments of the present disclosure includes: a first electronic device that transmits time information for synchronization using a wire communication circuit and that receives multimedia data including the time information using the wire communication circuit and that displays an image on a display using the received multimedia data and that outputs audio using an audio output device; and a second electronic device that encodes multimedia data in order to include the time information received from the first electronic device to correspond to reception of the time information and that transmits the encoded multimedia data to the first electronic device using the wire communication circuit.

FIG. 7 is a diagram illustrating an example structure of a data packet for transmitting sensor data and time information according to various example embodiments of the present disclosure.

With reference to FIG. 7, a data packet 700 for transmitting sensor data (first information) and time information (second information) according to various example embodiments of the present disclosure may include a record ID field 701, sample number field 703, timestamp field 705, and sensor data field 707.

The report ID field 701 may refer, for example, to a division unit using in a Human Interface Device (HID) protocol and stores information for distinguishing a kind of a USB data packet. The report ID field 701 may have a size of lbyte. The sample number field 703 stores information representing the sample number of sensor data. The sample number field 703 may have a size of lbyte. The timestamp field 705 stores time information for synchronization. The timestamp field 705 may have a size of 2 bytes. A size of the timestamp field 705 may be adjusted. For example, the timestamp field 705 may have a size of 4 bytes in order to represent larger time information. The sensor data field 707 stores sensor data. The sensor data field 707 may have a size of 60 bytes.

A data packet structure of FIG. 7 represents an example of transmitting sensor data and time information using a USB 2.0 interface, and various example embodiments of the present disclosure is not limited thereto. For example, a data packet according to various example embodiments of the present disclosure may use various methods of interfaces and may be formed in various structures.

FIG. 8 is a diagram illustrating an example packet structure for transmitting image data according to various example embodiments of the present disclosure.

With reference to FIG. 8, the second electronic device according to various example embodiments of the present disclosure may transmit a display frame 801 and audio frames 802 and 803 to the first electronic device using one endpoint. For example, when the second electronic device receives time information from the first electronic device, the second electronic device may generate the display frame 801 and the audio frames 802 and 803 including a timestamp 804 corresponding to the received time information and transmit the generated display frame 801 and audio frames 802 and 803 to the first electronic device using one endpoint. In this case, the second electronic device may alternatively transmit the display frame 801 and the audio frames 802 and 803.

In FIG. 8, the timestamp 804 is included in the display frame 801 and the audio frames 802 and 803, but an example embodiment of the present disclosure is not limited thereto. According to an example embodiment, the second electronic device may add and transmit a timestamp after the display frame and the audio frame.

FIG. 9 is a diagram illustrating an example packet structure for transmitting image data according to various example embodiments of the present disclosure.

With reference to FIG. 9, the second electronic device according to various example embodiments of the present disclosure may transmit each of display frames 911 and 912 and audio frames 921, 922, 923, and 924 using two different endpoints. For example, when the second electronic device receives time information from the first electronic device, the second electronic device may generate the display frames 911 and 912 and the audio frames 921, 922, 923, and 924 including a timestamp 904 corresponding to the received time information, transmit the generated display frames 911 and 912 to the first electronic device using a first endpoint, and transmit the generated audio frames 921, 922, 923, and 924 to the first electronic device using a second endpoint.

In FIG. 9, the timestamp 904 is included in the display frames 911 and 912 and the audio frames 921, 922, 923, and 924, but an example embodiment of the present disclosure is not limited thereto. For example, according to an example embodiment, the second electronic device may add and transmit a timestamp after the display frame and the audio frame.

FIG. 10 is a diagram illustrating an example method of synchronizing data according to various example embodiments of the present disclosure.

With reference to FIG. 10, a first electronic device 100 according to various example embodiments of the present disclosure may synchronize and output received display frames and audio frames using a plurality of endpoints. For example, when receiving time information from the first electronic device 100, the second electronic device 200 may generate a first display frame 1001 including a first timestamp 1021 and a second display frame 1002 including a second timestamp 1022 based on the received time information using a display encoder 1413a. Further, the second electronic device 200 may generate a first audio frame 1003 including a first timestamp 1021, a second audio frame 1004 including a second timestamp 1022, and a third audio frame 1005 including a third timestamp 1023 using an audio encoder 1413b. The second electronic device 200 may transmit the generated first display frame 1001, second display frame 1002, first audio frame 1003, second audio frame 1004, and third audio frame 1005 to the first electronic device.

A first processor 1310 of the first electronic device 100, having received the frames 1001, 1002, 1003, 1004, and 1005 may synchronize and output the frames 1001, 1002, 1003, 1004, and 1005. For example, the first processor of the first electronic device 100 may simultaneously transmit, synchronize, and output the first display frame 1001 and the first audio frame 1003 including the first timestamp 1021 to a display module 1360 and a speaker 1380, respectively and may simultaneously transmit, synchronize, and output the second display frame 1002 and the second audio frame 1004 including the second timestamp 1022 to the display module 1360 and the speaker 1380, respectively.

According to an example embodiment, the first processor 1310 may select a frame to output based on output time information. For example, when it is unnecessary to output a frame including the first timestamp 1021 (e.g., a real time is important, but when time information corresponding to the first timestamp 1021 has a larger difference of a reference time (e.g., two seconds) or more than current time information), the first processor 1310 may transmit and output only the second display frame 1002 and the second audio frame 1004 including the second timestamp 1022 among the first display frame 1001, the first audio frame 1003, the second display frame 1002, and the second audio frame 1004 to the display module 1360 and the speaker 1380.

According to an example embodiment, the first processor 1310 of the first electronic device may receive information (time information) for selecting a frame output from the second processor. A more detailed description thereof will be provided below with reference to FIG. 11.

FIG. 11 is a flow diagram illustrating an example method of synchronizing data according to various example embodiments of the present disclosure.

With reference to FIG. 11, a first electronic device 1100 according to various example embodiments of the present disclosure may transmit time information to the second electronic device 1200 at operation 1101. In this case, the first electronic device 1100 may transmit sensor data. The second electronic device 1200, having received the first time information may generate a display frame and an audio frame including the time information at operation 1103. The second electronic device 1200 may transmit the generated frames to the first electronic device at operation 1105.

A first processor of the first electronic device 1100 may receive output time information from a second processor at operation 1107.

When receiving the output time information, the first processor may transmit data related to a timestamp corresponding to the output time information among the received frames to the output module at operation 1109. For example, the first processor may transmit video data related to a timestamp corresponding to the output time information to the display module and transmit audio data related to a timestamp corresponding to the output time information to the speaker.

As described above, in a first electronic device 1100 according to various example embodiments of the present disclosure, when the second processor together with a first processor transmits time information to the first electronic device 1100, a time difference until actually outputting data corresponding to the time information may be measured and thus output latency can be easily determined. Further, because the first electronic device 1100 according to various example embodiments of the present disclosure may select output time information, output latency may be appropriately adjusted. For example, when a processing of received multimedia data is delayed due to various causes (e.g., overload of the first processor, low power mode due to battery shortage), by discarding old partial data, output latency may be reduced. Alternatively, when the second processor of the first electronic device 1100 receives a signal representing that the first electronic device moves a reference distance or more within a reference time through various sensors (e.g., acceleration sensor, motion sensor), the second processor may transmit current time information to the first processor, discard multimedia data having time information before current time information, and output multimedia data corresponding to the current time information. For example, while the user views a front surface, when the user quickly turns a head to the right side, the second processor of the first electronic device 1100 may detect the turn through the sensor and transmit current time information of the detected time point to the first processor. Thereby, in the first electronic device 1100 according to various example embodiments of the present disclosure, as the user turns the head to the right side, data related to a right side direction should be output, and the user entirely outputs data related to the user's previous viewed direction (e.g., a front surface) existing at a buffer and outputs data related to the right side direction and thus a problem may be solved that the user feels that a real time is deteriorated.

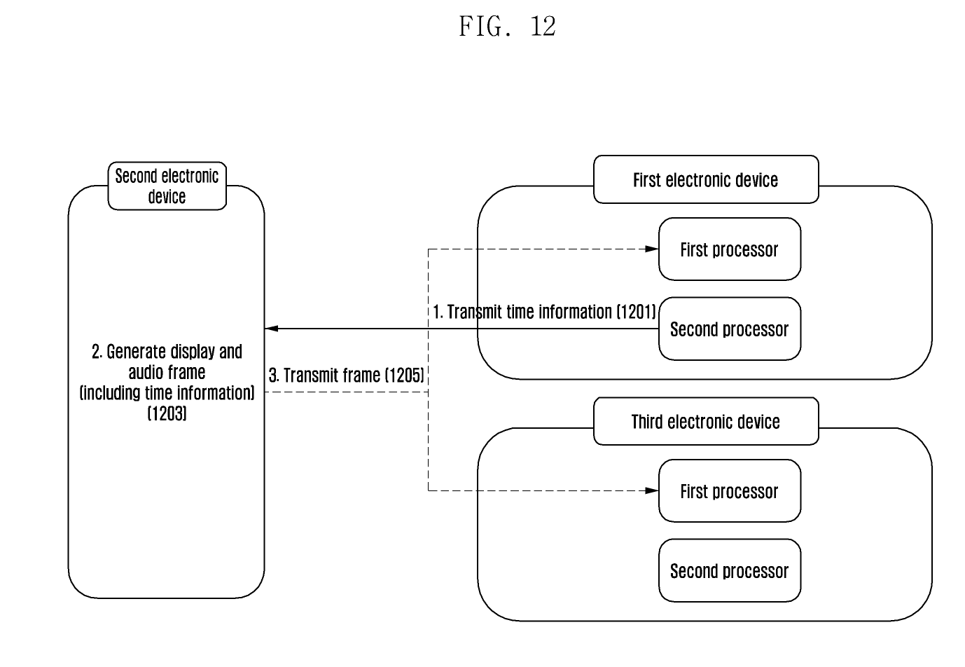

FIG. 12 is a flow diagram illustrating an example method of synchronizing data according to various example embodiments of the present disclosure.

With reference to FIG. 12, the first electronic device according to various example embodiments of the present disclosure may transmit time information to the second electronic device at operation 1201. In this case, the first electronic device may transmit the time information together with sensor data.

The second electronic device, having received the time information may generate a display frame and an audio frame including the time information at operation 1203. The second electronic device may transmit the generated frames to the first electronic device and a third electronic device at operation 1205. The first electronic device and the third electronic device, having received the generated frames may synchronize and output display data and audio data included in the received frames using the above-described synchronizing method.

According to an example embodiment, the first electronic device and the third electronic device may be connected by wire or wireless. The first electronic device and the third electronic device may share output time information that selects data to output. Thereby, the first electronic device and the third electronic device may simultaneously output multimedia data related to the same output time information. For example, when outputting multimedia data related to time information of 10, the first electronic device may share the time information of 10 with the third electronic device, and the third electronic device may output multimedia data related to the time information of 10. Therefore, in an example embodiment of the present disclosure, when a plurality of users view the same movie using the electronic device, the plurality of users can view the same scene at the same time point. In this way, in various example embodiments of the present disclosure, a problem can be prevented that outputs different scenes according to a processing ability of a plurality of electronic devices.

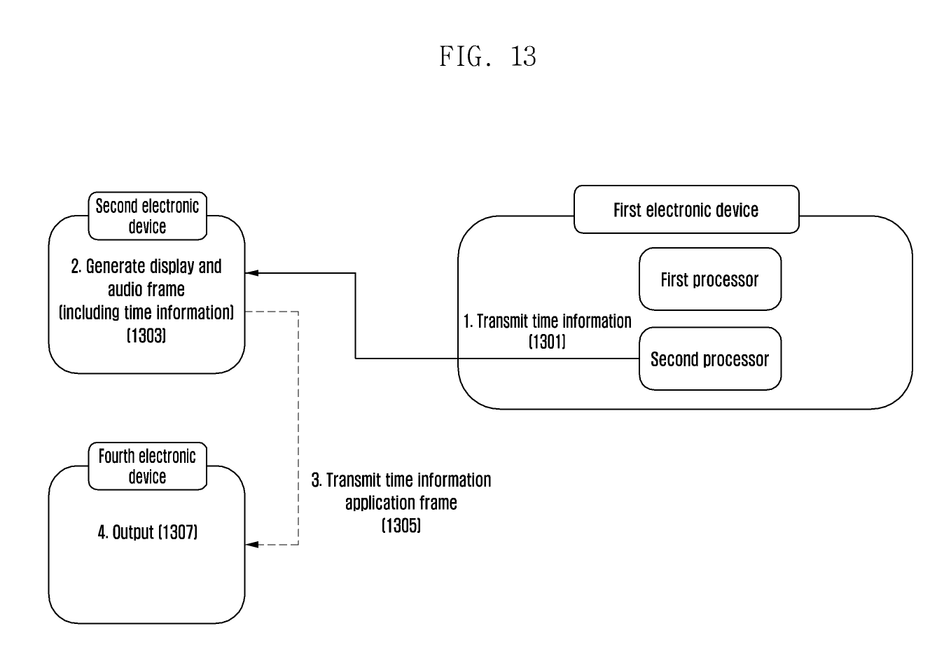

FIG. 13 is a flow diagram illustrating an example method of synchronizing data according to various example embodiments of the present disclosure.

With reference to FIG. 13, the first electronic device according to various example embodiments of the present disclosure may transmit time information to the second electronic device at operation 1301. In this case, the first electronic device may transmit the time information together with sensor data.

The second electronic device, having received the time information may generate a display frame and an audio frame including the time information at operation 1303. The second electronic device may transmit the generated frames to a fourth electronic device at operation 1305. The fourth electronic device may be an electronic device that can output multimedia data such as a television and a monitor. The fourth electronic device, having received the generated frames may synchronize and output the received frames using the above-described synchronizing method at operation 1307.

According to an example embodiment, the fourth electronic device may retransmit the received frames to another electronic device (e.g., HMD, content sharing device).

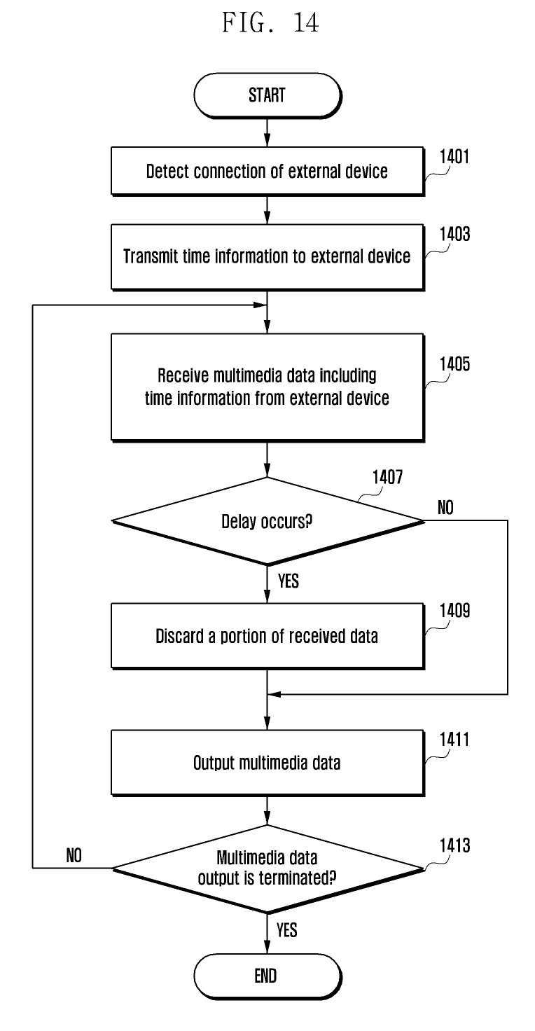

FIG. 14 is a flowchart illustrating an example method of synchronizing data of an electronic device according to various example embodiments of the present disclosure.

With reference to FIG. 14, an electronic device (e.g., the first electronic device) according to various example embodiments of the present disclosure may detect a connection of an external device (e.g., the second electronic device) at operation 1401. The electronic device may not autonomously perform synchronization and may be connected to the external device through a wire communication circuit that does not include a separate signal line for synchronization. For example, the wire communication circuit may be an interface of a USB Type-C method.

The electronic device (e.g., a second processor of the first electronic device) may transmit time information for synchronization to the connected external device at operation 1403. The electronic device may transmit the time information through a first interface of the wire communication circuit. For example, the electronic device may transmit the time information through a USB 2.0 interface of a USB Type-C. According to an example embodiment, the electronic device may transmit the time information together with sensor data. The time information may use an internal time of the first electronic device.

The electronic device (e.g., the first processor of the first electronic device) may receive multimedia data (e.g., a display frame and an audio frame) including the time information from the external device at operation 1405. The electronic device may receive the multimedia data through a second interface of the wire communication circuit. For example, the electronic device may receive the multimedia data through a USB 3.0 interface of a USB Type-C. The electronic device may receive the multimedia data using one endpoint or may receive the multimedia data using a plurality of endpoints.

The electronic device (e.g., the first processor of the first electronic device) may determine whether delay in reception of the multimedia data occurs at operation 1407. The delay may occur due to rapid increase of data or an overload or may occur when the electronic device moves by a reference distance or more within a reference time.

If delay in reception of the multimedia data does not occur, the electronic device (e.g., the first processor of the first electronic device) may perform operation 1411 to be described later. If delay in reception of the multimedia data occurs, the electronic device (e.g., the first processor of the first electronic device) may discard a portion of received multimedia data at operation 1409.

The electronic device (e.g., the first processor of the first electronic device) may output multimedia data at operation 1411. For example, if delay in reception of the multimedia data does not occur, the electronic device may display an image (display data) in the display module using the received multimedia data and output audio through an audio output module (e.g., the speaker). If delay in reception of the multimedia data occurs, the electronic device may display an image in the display module using image data whose portion is discarded and output audio through the audio output module. Specifically, the electronic device may decode a video packet included in multimedia data to transmit the video packet to the display module and decode an audio packet included in the multimedia data to transmit the audio packet to the audio output module. Here, the electronic device may synchronize and output an image and audio using the above-described various synchronizing methods.

The electronic device (e.g., the first processor of the first electronic device) may determine whether multimedia data output is terminated at operation 1413. For example, the electronic device may determine whether a connection to the external device is released. If multimedia data output is terminated, the electronic device may terminate data synchronization according to an example embodiment of the present disclosure. If multimedia data output is not terminated, the process returns to operation 1405 and the electronic device may repeat the above-described operation.

A method of synchronizing data of a head mounted device (e.g., the first electronic device 100 or the electronic device 300) according to various example embodiments of the present disclosure includes: transmitting first information based on a first signal representing a movement of the head mounted device to an electronic device (e.g., the second electronic device 200 or the electronic device 400) connected through a communication circuit (e.g., the USB module 321) using the communication circuit; transmitting second information including a time related to the first signal to the electronic device using the communication circuit; receiving multimedia data and third information related to the multimedia data corresponding to a time from the electronic device using the communication circuit; discarding a portion of the multimedia data based on the second information and the third information; and displaying an image on a display (e.g., the display 30 or the display module 360) using the multimedia data whose portion is discarded and outputting audio using an audio output device (e.g., the speaker 380).

According to various example embodiments, the communication circuit may correspond to a USB 3.0 type-C specification.

According to various example embodiments, the communication circuit may include: a first interface that transmits the first information and the second information; and a second interface that receives the multimedia data and the third information.

According to various example embodiments, receiving multimedia data and third information related to the multimedia data corresponding to a time from the electronic device using the communication circuit may include: receiving a display frame and an audio frame including the multimedia data with one endpoint; or receiving the display frame or the audio frame with different endpoints.

According to various example embodiments, displaying an image on a display using multimedia data whose portion is discarded and outputting audio using an audio output device may include synchronizing display data included in the display frame and audio data included in the audio frame using time information included in each of the display frame and the audio frame.

According to various example embodiments, discarding a portion of the multimedia data based on the second information and the third information may include discarding, when a difference between the second information and the third information is a predetermined reference value or more, a portion of the received multimedia data.

According to various example embodiments, the method may further include sharing output time information with another head mounted device connected by wire or wirelessly.

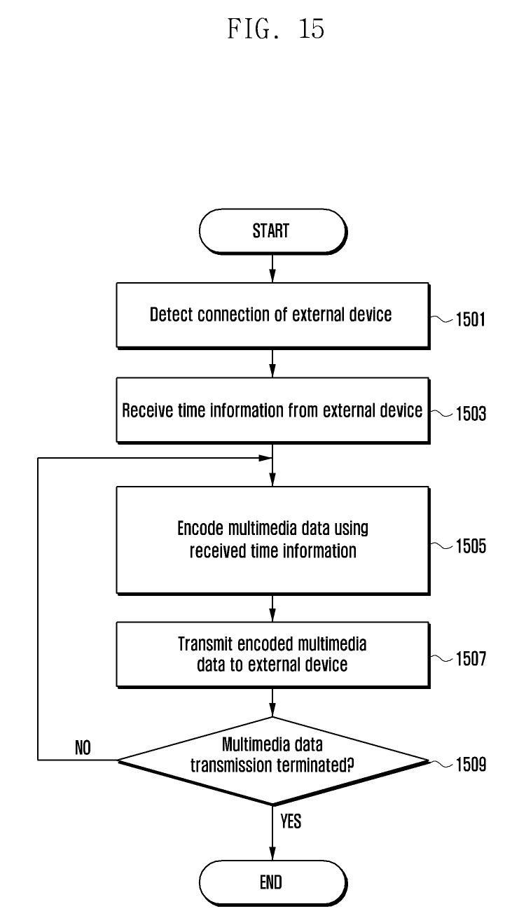

FIG. 15 is a flowchart illustrating an example method of synchronizing data of an electronic device according to various example embodiments of the present disclosure.

With reference to FIG. 15, an electronic device (e.g., a processor of the second electronic device) according to various example embodiments of the present disclosure may detect a connection of an external device (e.g., a first electronic device) at operation 1501. The electronic device may not autonomously perform synchronization and may be connected to an external device through a wire communication circuit that does not include a separate signal line for synchronization. For example, the wire communication circuit may be an interface of a USB Type-C method.

The electronic device (e.g., a processor of the second electronic device) may receive time information for synchronization from the connected external device at operation 1503. The electronic device may receive the time information through a first interface of the wire communication circuit. For example, the electronic device may receive the time information through a USB 2.0 interface of a USB Type-C. According to an example embodiment, the electronic device may receive the time information together with sensor data.

The electronic device (e.g., a processor of the second electronic device) may encode multimedia data (e.g., a display frame and an audio frame) using time information received from the external device at operation 1505. The electronic device (e.g., a processor of the second electronic device) may transmit the encoded multimedia data to the external device at operation 1507. For example, the electronic device may transmit the multimedia data through a second interface of the wire communication circuit. For example, the electronic device may transmit the multimedia data through a USB 3.0 interface of a USB Type-C. The electronic device may transmit a display frame and an audio frame constituting the multimedia data using one endpoint or may transmit each of a display frame and an audio frame using different endpoints.

The electronic device (e.g., a processor of the second electronic device) may determine whether multimedia data transmission is terminated at operation 1509. For example, the electronic device may determine whether a connection to the external device is released. If multimedia data transmission is terminated, the electronic device may terminate data synchronization according to an example embodiment of the present disclosure. If multimedia data transmission is not terminated, the process returns to operation 1505 and the electronic device may repeat the above-described operation.

A method of synchronizing data of an electronic device (e.g., the second electronic device 200 or the electronic device 400) according to various example embodiments of the present disclosure includes: detecting a connection with another electronic device (e.g., the first electronic device 100 or the electronic device 300) through a communication circuit (e.g., the USB module 421); receiving time information for synchronization from the another electronic device through the communication circuit; encoding multimedia data to include the received time information; and transmitting the encoded multimedia data to the another electronic device using the communication circuit.

According to various example embodiments, the communication circuit may correspond to a USB 3.0 type-C specification.

According to various example embodiments, the communication circuit may include: a first interface that receives the time information; and a second interface that transmits the encoded multimedia data.

According to various example embodiments, transmitting the encoded multimedia data to the another electronic device using the communication circuit may include: transmitting a display frame and an audio frame comprising the multimedia data using one endpoint; or transmitting the display frame or the audio frame using different endpoints.

According to various example embodiments, transmitting the encoded multimedia data to the another electronic device using the communication circuit may further include transmitting the multimedia data to at least one another electronic device different from the another electronic device when transmitting the multimedia data.

The term “module” used in this disclosure may refer to a certain unit that includes one of hardware, software and firmware or any combination thereof. The module may be interchangeably used with unit, logic, logical block, component, or circuit, for example. The module may be the minimum unit, or part thereof, which performs one or more particular functions. The module may be formed mechanically or electronically. For example, the module disclosed herein may include at least one of a dedicated processor, a CPU, an ASIC (Application-Specific Integrated Circuit) chip, FPGAs (Field-Programmable Gate Arrays), and programmable-logic device, which have been known or are to be developed.

The above-described example embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

According to various example embodiments, in a computer readable storage medium that stores instructions, when executed by the at least one processor, cause the at least one processor to perform at least one operation, the at least one operation may include transmitting first information based on a first signal representing a movement of a head mounted device to an electronic device (e.g., the second electronic device 200 or the electronic device 400) connected through a communication circuit (e.g., the USB module 321) using the communication circuit; transmitting second information including a time related to the first signal to the electronic device using the communication circuit; receiving multimedia data and third information related to the multimedia data corresponding to a time using the communication circuit from the electronic device; discarding a portion of the multimedia data based on the second information and the third information; and displaying an image on a display (e.g., the display 30 or the display module 360) using the multimedia data whose portion is discarded and outputting audio using an audio output device (e.g., the speaker 380).

According to various example embodiments, in a computer readable storage medium that stores instructions, which, when executed by the at least one processor, cause the at least one processor to perform at least one operation, the at least one operation may include detecting a connection to another electronic device (e.g., the first electronic device 100 or the electronic device 300) through a communication circuit (e.g., the USB module 421); receiving time information for synchronization from the another electronic device through the communication circuit; encoding multimedia data to include the received time information; and transmitting the encoded multimedia data to the another electronic device using the communication circuit.

According to various example embodiments of the present disclosure, synchronization can be easily performed between electronic devices (e.g., HMD device and contents sharing device) having no separate physical line for synchronization.

Further, according to various example embodiments of the present disclosure, because synchronization is performed using an internal time of an electronic device (e.g., HMD device), the electronic device (e.g., HMD device) can autonomously synchronize data.

Further, according to various example embodiments of the present disclosure, after transmitting time information, latency until data corresponding to the time information are output can be measured. Therefore, an electronic device (e.g., HMD device) according to various example embodiments of the present disclosure can adjust latency. For example, when latency is extended, the electronic device (e.g., HMD device) can discard a portion (e.g., old packet) of a packet stored at a buffer and prevent and/or reduce an increase of latency by reproducing a new packet.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

Various example embodiments disclosed herein are provided merely to describe technical details of the present disclosure and to aid in the understanding of the present disclosure, and are not intended to limit the scope of the present disclosure. Therefore, it should be understood that all modifications and changes or modified and changed forms based on the technical idea of the present disclosure fall within the scope of the present disclosure.

What is claimed is:

1. A head mounted device, comprising:
a housing comprising a surface;
a connection apparatus connected to the housing and configured to detachably connect the housing to a portion of a user head;
a display exposed through a portion of the surface;
a motion sensor located at the housing or connected to the housing and configured to provide a first signal representing a movement of the housing;
a communication circuit;
a processor electrically connected to the display and the communication circuit; and
a memory electrically connected to the processor and configured to store instructions,
wherein the processor is configured to execute the instructions to receive the first signal from the motion sensor, to transmit first information based on the first signal using the communication circuit, to transmit second information including a time related to the first signal using the communication circuit, to receive multimedia data and third information related to the multimedia data corresponding to a time using the communication circuit, to discard a portion of the multimedia data based on the second information and the third information, and to display an image on the display using the multimedia data whose portion is discarded and to output audio using an audio output module comprising audio output circuitry.

2. The head mounted device of claim 1, wherein the communication circuit corresponds to a Universal Serial Bus (USB) 3.0 type-C specification.

3. The head mounted device of claim 1, wherein the communication circuit comprises:
a first interface configured to transmit the first information and the second information; and
a second interface configured to receive the multimedia data and the third information.

4. The head mounted device of claim 1, wherein the multimedia data include a display frame and an audio frame, and
wherein processor is configured to receive the display frame and the audio frame using one endpoint of the communication circuit or to receive each of the display frame and the audio frame using different endpoints of the communication circuit.

5. The head mounted device of claim 4, wherein the memory further stores an instruction to synchronize display data included in the display frame and audio data included in the audio frame using time information included in each of the display frame and the audio frame.

6. The head mounted device of claim 1, wherein the processor is configured to discard a portion of the received multimedia data, if a difference between the second information and the third information is a predetermined reference value or more.

7. The head mounted device of claim 1, wherein the processor is configured to share output time information with another head mounted device connected by a wire or wirelessly.

8. An electronic device, comprising:
a communication circuit;
a memory configured to store multimedia data and instructions; and
a processor electrically connected to the communication circuit and the memory,
wherein the processor is configured to execute the instructions to receive time information from another electronic device connected through the communication circuit using the communication circuit; to encode multimedia data to include the received time information, and to transmit the encoded multimedia data to the another electronic device using the communication circuit.

9. The electronic device of claim 8, wherein the communication circuit corresponds to a Universal Serial Bus (USB) 3.0 type-C specification.

10. The electronic device of claim 8, wherein the communication circuit comprises:
a first interface configured to receive the time information; and
a second interface configured to transmit the encoded multimedia data.

11. The electronic device of claim 8, wherein the multimedia data include a display frame and an audio frame, and
wherein the processor is configured to transmit the display frame and the audio frame using one endpoint of the communication circuit or to transmit each of the display frame and the audio frame using different endpoints of the communication circuit.

12. The electronic device of claim 8, wherein the memory further stores an instruction to transmit the encoded multimedia data to at least one another electronic device distinguished from the another electronic device when transmitting the encoded multimedia data.

13. A method of synchronizing data of a head mounted device, the method comprising:
transmitting first information based on a first signal representing a movement of the head mounted device to an electronic device connected through a communication circuit using the communication circuit;
transmitting second information including a time related to the first signal to the electronic device using the communication circuit;
receiving multimedia data and third information related to the multimedia data corresponding to a time received from the electronic device using the communication circuit;
discarding a portion of the multimedia data based on the second information and the third information; and
displaying an image on a display using the multimedia data whose portion is discarded and outputting audio using an audio output device.

14. The method of claim 13, wherein the wire communication circuit corresponds to a Universal Serial Bus (USB) 3.0 type-C specification.

15. The method of claim 13, wherein the communication circuit comprises:
a first interface configured to transmit the first information and the second information; and
a second interface configured to receive the multimedia data and the third information.

16. The method of claim 13, wherein receiving multimedia data and third information related to the multimedia data corresponding to a time from the electronic device using the communication circuit comprises:
receiving a display frame and an audio frame comprising the multimedia data with one endpoint of the communication circuit; or
receiving each of the display frame and the audio frame with different endpoints of the communication circuit.

17. The method of claim 16, wherein displaying an image on a display using the multimedia data whose portion is discarded and outputting audio using an audio output device comprises: synchronizing display data included in the display frame and audio data included in the audio frame using time information included in each of the display frame and the audio frame.

18. The method of claim 13, wherein discarding a portion of the multimedia data based on the second information and the third information comprises: discarding, when a difference between the second information and the third information is a predetermined reference value or more, a portion of the received multimedia data.

19. The method of claim 13, further comprising: sharing output time information with another head mounted device connected by a wire or wirelessly.
